(19) United States
(12) Patent Application Publication
(10) Pub. No.: US 2003/0089728 A1
(43) Pub. Date: May 15, 2003

(54) Delivery chute system for gravity game

(76) Inventors: Jeffrey C. Ostler, Alpine, UT (US); Robert Scott, Lehi, UT (US)

Correspondence Address: KIRTON AND MCCONKIE, 1800 EAGLE GATE TOWER, 60 EAST SOUTH TEMPLE, P O BOX 45120, SALT LAKE CITY, UT, 84145-0120, US

(21) Appl. No.: 09/993,796

(22) Filed: Nov. 15, 2001

(51) Int. Cl. G07F 11/00; B65H 3/00

(52) U.S. Cl. 221/107; 221/263

(57) ABSTRACT

A delivery system that delivers rounded prize capsules in an arcade-type skill game. Several slanted channels store capsules that line up naturally within a vertical agitator column. An electrically-activated capsule transport located beneath the agitator column moves over a hole through which a capsule transported in the transport falls for delivery to the game patron. The capsule transport's movement causes the delivery chute to move vertically upward and allow the next-in-line, topmost capsule in the channels to fall into the agitator column. The capsule transport then moves back to its original position, causing the agitator column to lower and allow the lowermost capsule in the agitator column to fall into the capsule transport in preparation for the next delivery. Preferably, the delivery system is embodied within a skill game in which a player rocks a ball back and forth up a ridged hill and into a hole at the top.

### BACKGROUND

1. Field of the Invention

The present invention relates generally to methods and systems for delivering rounded articles. More particularly, the present invention relates to movable delivery chutes that deliver prizes in gravity-based interactive skill games.

2. Background Art

There are several types of article delivery systems available for vending or arcade-type machines. These systems may deliver articles such as gumballs, soda cans, or stuffed animals. Some of these systems use gravity to dispense the article. Among these gravity-based delivery systems are those that dispense rounded articles which are stacked in order so that the rounded articles are dispensed sequentially, the next item to be dispensed falling into place at the time that an item is dispensing.

Many article delivery systems, in particular, those that use gravity to dispense rounded objects, require that the machine containing the delivery mechanism have a large footprint (“footprint” means the floor space occupied by a structure or device). For example, the delivery system commonly used in gumball machines uses a flat, horizontally oriented dispensing wheel to dispense a gumball from among a hopper of gumballs located above the horizontal dispensing wheel. When a person or customer twists a handle external to the gumball machine, a mechanical connection to the latter horizontal dispensing wheel causes the dispensing wheel to rotate in the horizontal plane. At a certain point in the rotation, the dispensing wheel is oriented so that a gumball is allowed to drop through a hole in the dispensing wheel for distribution to the customer. This horizontal dispensing wheel works well for dispensing small objects. However, when adapted to dispense large objects, such a dispensing wheel would have to be placed in a machine with a large footprint to accommodate the need for a significantly larger diameter in the horizontal wheel (the larger the rounded object, the larger the hole in the wheel needs to be in order to compensate not only for the increased diameter of the rounded object but also for the decreased agitation propensity—i.e., when the rounded objects in the hopper are large, it becomes more difficult for a single rounded object to disengage from its adjacent rounded objects so that it can fall through a hole in the horizontal wheel). Such unnecessary machine width is undesirable because it adds to manufacturing costs as well as makes the machine unwieldy. Indeed, for rounded objects with an approximate diameter of four inches, the horizontal wheel—and thus also the footprint—would have to be unreasonably large.

In addition, dispensing machines existing in the art store rounded articles in an inefficient or inconvenient manner. For example, most gumball machines store the gumballs as one big heap in a single hopper. Because the weight of articles at the top of the heap bears down on the articles below, the latter manner of storage does not work well for storing a large volume of articles or for storing articles that are fragile. To solve this problem, some dispensing machines store rounded articles lined up in channels that zigzag. However, the zigzag configuration of these machines is an inefficient use of space and limits the number of articles that can be stored because the space between the zigzagged channels is unavailable for storing articles.

### SUMMARY AND OBJECTS OF THE INVENTION

The present invention may be characterized generally as a vertically movable delivery chute or agitator column that delivers rounded prize capsules in an interactive skill game of the type that would typically be found in a video game arcade. Several fixed slanted channels store the rounded capsules. The vertically movable agitator column, located adjacent to the slanted channels, also contains rounded capsules delivered to it from the slanted channels.

The agitator column has a first resting position and a second raised agitating position. In the first position, gravity causes the last capsule in the delivery chute/agitator column to naturally fall into and rest in a hole in a capsule transport located below the delivery chute. Upon activation of an electrical switch, a disc in mechanical communication with the capsule transport is preferably rotated, causing the capsule transport to move forward towards the game patron and over a hole through which the capsule falls for delivery to the game patron. As the capsule transport moves forward, a pivot bar or other suitable device causes the delivery chute to agitate vertically upward to the second raised position so as to receive another capsule in the topmost capsule queue. As the disc continues its rotation, the capsule transport is moved back to its original position, and the pivot bar lowers the delivery chute to its original position, thereby allowing the lowermost capsule in the delivery chute to fall into the capsule transport hole in preparation for the next delivery. The agitator column and the parallel configuration of the slanted channels provide several advantages, including improved capsule weight distribution, increased ability to hold a large volume of capsules in a minimal amount of space, and the minimization of capsule damage.

In the preferred embodiments, the delivery chute mechanism is embodied within a machine incorporating a game involving a ridged hill that a player rocks from side to side using a handlebar that correspondingly rocks from side to side, pivoting at its midpoint. By rocking the hill from side to side, the player attempts to move a small ball from the bottom of the hill to one of two holes at the top. If the ball falls into the topmost hole, the player wins a large prize that is encapsulated within the rounded prize capsule and dispensed by the delivery chute system. If the ball falls into the hole just below the topmost hole, the player wins a small prize that is dispensed via a traditional horizontal dispensing wheel commonly found in gumball machines.

Accordingly, it is an object of some embodiments of the present invention to provide a movable delivery chute system having a vertical agitator column that moves from a first lowered position to a second raised position as well as a set of parallel slanted channels adjacent to the agitator column.

Another object of some embodiments of the present invention is to provide a delivery system for rounded objects that provides for improved weight distribution of the rounded objects.

Another object of some embodiments of the present invention is to provide a delivery system for rounded objects that provides increased ability to hold a large volume of capsules in a minimal amount of space as well as for a minimization of capsule damage.

Another object of some embodiments of the present invention is to provide a delivery system for rounded objects that enables gravity-based delivery of rounded objects within a machine having a small footprint.

Another object of some embodiments of the present invention is to provide an arcade-type skill game wherein prizes are dispensed by a vertically movable chute and horizontally movable capsule transport.

A further object of some embodiments of the present invention is to provide a gravity-based article delivery system wherein the articles to be delivered are rounded objects that are stored in fixed slanted channels which gravitationally feed into a vertically movable vertical channel that can separate the articles in the channel from those in the slanted channels and wherein the vertical channel agitates upwards and downwards.

Another object of some embodiments of the present invention is to provide a prize dispensing system wherein the prizes are enclosed in rounded plastic capsules and delivered via a capsule transport that is moved by an electronically activated disc.

Yet another object of some embodiments of the present invention is to provide a skill game wherein a player must move a ball up a ridged hill by pivoting the hill back and forth until the ball either drops off the edge of the hill or falls into a hole at the top of the hill.

Another object of some embodiments of the present invention is to provide a skill game wherein a player rocks a ridged mountain piece from side to side using a handlebar.

A further object of some embodiments of the present invention is to provide an arcade-type skill game wherein a player rocks a vertically oriented ridged hill from side to side in attempt to win an encapsulated prize that is dispensed via a vertically movable delivery chute and a horizontally movable capsule transport.

These and other objects and features of the present invention will become more fully apparent from the following description and drawings. Other objects will likewise become apparent from the practice of the invention as set forth hereafter.

### BRIEF DESCRIPTION OF THE DRAWINGS

The foregoing and other objects and features of the present invention will become more fully apparent from the accompanying drawings when considered in conjunction with the following description and appended claims. Although the drawings depict only typical embodiments of the invention and are thus not to be deemed limiting of the invention's scope, the accompanying drawings help explain the invention in added detail.

FIG. 1 is a perspective view of one embodiment of the article delivery system of the present invention wherein the delivery chute is in a lowered position, and the capsule transport is in resting position.

FIG. 2 is a perspective view of the embodiment in FIG. 1 wherein the delivery chute is in a raised position and the capsule transport is in a forward position.

FIG. 3 is a perspective view of the embodiment in FIG. 1 wherein the delivery chute system is placed in a partially-assembled, open console.

FIG. 4 is a top plan view of one embodiment of the rotatable disc of the present invention.

FIG. 5 shows the embodiment of FIG. 1 shown from an inside angle.

FIG. 6 is an enlarged view of the bottom portion of FIG. 5.

FIG. 7 is an enlarged view of the bottom portion of FIG. 1.

FIG. 8 is an enlarged view of the bottom portion of FIG. 2.

FIG. 9 shows a front plan view of the embodiment of FIG. 1.

FIG. 10 shows a back plan view of the embodiment of FIG. 1.

FIG. 11 shows a right side view of the embodiment of FIG. 1.

FIG. 12 shows a left side view of the embodiment of FIG. 1.

FIG. 13 shows a top plan view of the embodiment of FIG. 1.

FIG. 14 shows bottom plan view of the embodiment of FIG. 1.

FIG. 15 is a perspective view of one embodiment of the skill game of the present invention that incorporates an exemplary delivery chute system of the present invention.

FIGS. 16-18 are partial perspective views of the embodiment in FIG. 15.

FIG. 19 is an exploded front perspective view of one embodiment of the present invention showing the bottom tray as two separate pieces.

FIG. 20 is an exploded back perspective view of the embodiment in FIG. 19.

FIG. 21 is a partial back perspective view of the embodiment in FIG. 20 wherein the handlebar is placed in the u-shaped channel on the front of the machine.

FIG. 22 is an enlarged, partial, back perspective view of the embodiment in FIG. 21.

FIGS. 23 and 24 show two embodiments of the hill piece of the present invention.

### DETAILED DESCRIPTION OF EMBODIMENTS OF THE PRESENT INVENTION

The following detailed description, in conjunction with the accompanying drawings (hereby expressly incorporated as part of this detailed description), sets forth specific numbers, materials, and configurations in order to provide a thorough understanding of the present invention. The following detailed description, in conjunction with the drawings, will enable one skilled in the relevant art to make and use the present invention.

The purpose of this detailed description being to describe the invention so as to enable one skilled in the art to make and use the present invention, the following description sets forth various specific examples, also referred to as “embodiments,” of the present invention. While the invention is described in conjunction with specific embodiments, it will be understood, because the embodiments are set forth for explanatory purposes only, that this description is not intended to limit the invention to these particular embodiments. Indeed, it is emphasized that the present invention can be embodied or performed in a variety of ways. The drawings and detailed description are merely representative of particular embodiments of the present invention.

Reference will now be made in detail to several embodiments of the invention. The various embodiments will be described in conjunction with the accompanying drawings wherein like elements are designated by like alphanumeric characters throughout.

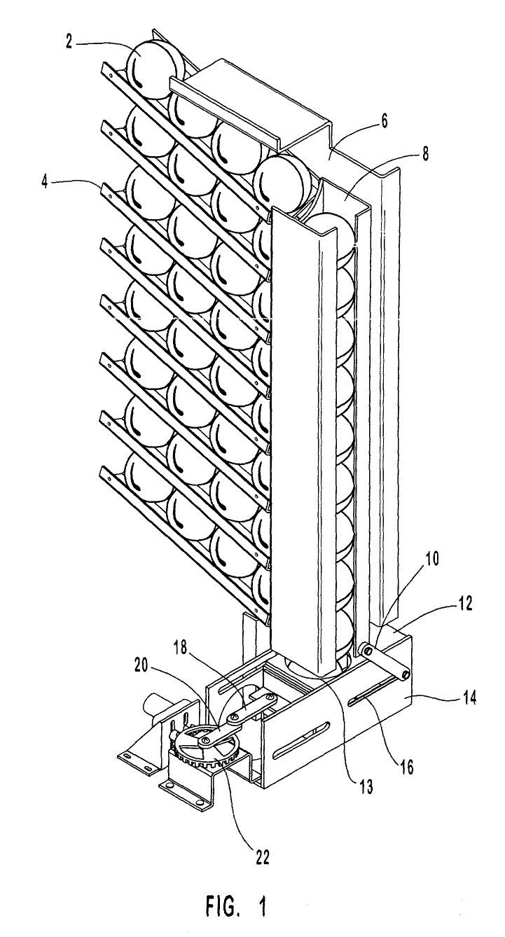

With reference now to the accompanying drawings, FIG. 1 shows a perspective view of one embodiment of the article delivery system for use in arcade-type games or vending machines. Several rounded articles or capsules 2 are stored in slanting channels 4 that are preferably fixed to a back panel 6 and are adjacent to one side of a delivery chute or agitator column 8. The rounded articles or capsules 2 can be a variety of things, including large gumballs, plastic spheres, or toy balls. In the preferred embodiments, the capsules 2 are see-through, hollow, plastic, substantially spherical, about four inches in diameter, and contain a prize inside.

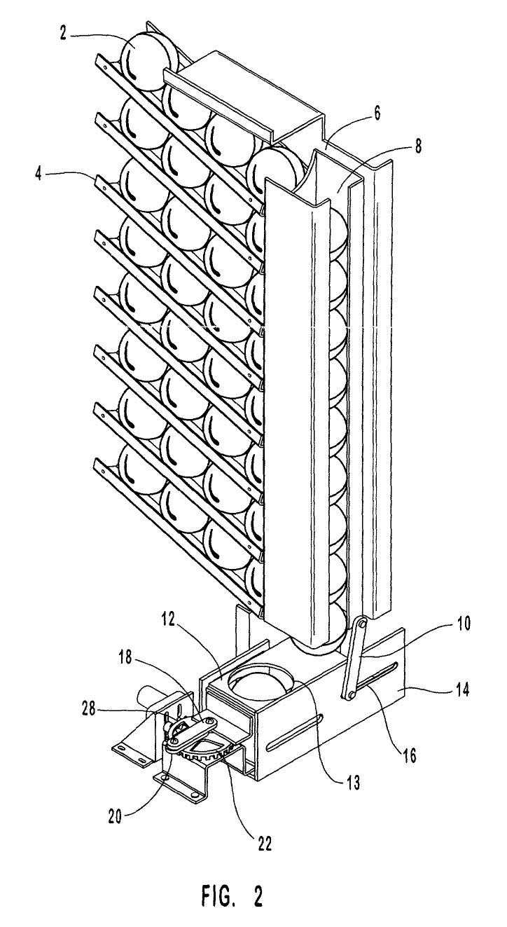

Gravity causes the capsules 2 in the slanting channels 4 to fall naturally towards the delivery chute 8. The delivery chute 8 is movable, preferably in a substantially vertical direction, with respect to the back panel 6 and the slanting channels 4. The delivery chute 8 is open at the bottom so that capsules 2 contained therein naturally drop (i.e., they are pulled by gravity) downward into a hole 13 (shown more clearly in FIG. 2) in the top of a capsule transport 12 when the capsule transport 12 is positioned so that the hole 13 is directly below the bottom opening of the delivery chute 8. The capsule transport 12 is movable, along a stationary transport guide 14, within a plane substantially perpendicular to the longitudinal plane of the delivery chute 8.

In the preferred embodiments, the capsule transport 12 is attached to the delivery chute 8 via a pivot bar 10 which is pivotally connected to the delivery chute 8. With respect to the connection of the pivot bar 10 to the capsule transport 12, the pivot bar 10 is fixedly attached to the capsule transport 12 so that the connection slides along an elongated slot 16 in the transport guide 14 when the capsule transport 12 moves along the transport guide 14.

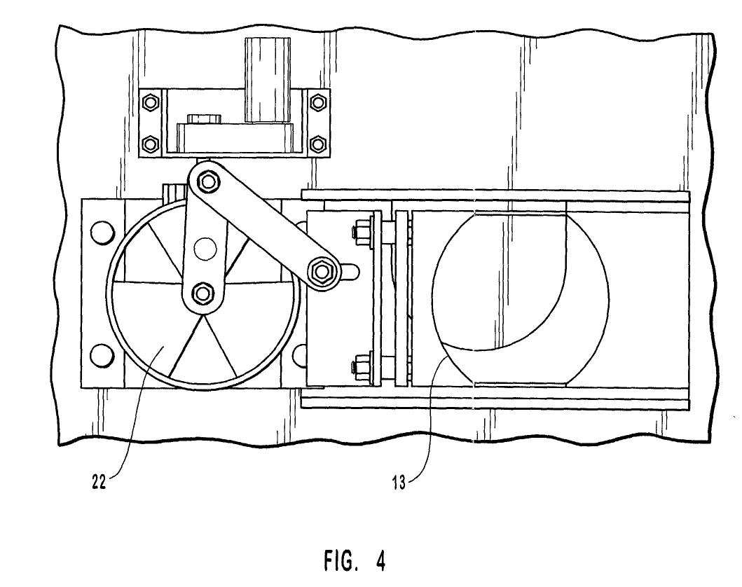

Also, in the preferred embodiments, the capsule transport 12 is attached to a transport bar 18, which transport bar 18 is pivotally attached to a disc bar 20, the latter disc bar 20 being fixedly attached to a substantially flat, horizontally rotatable disc 22. In the embodiment depicted in FIG. 1, the disc 22 is a cog wheel. However, as shown in FIG. 4, the disc 22 need not be cogged.

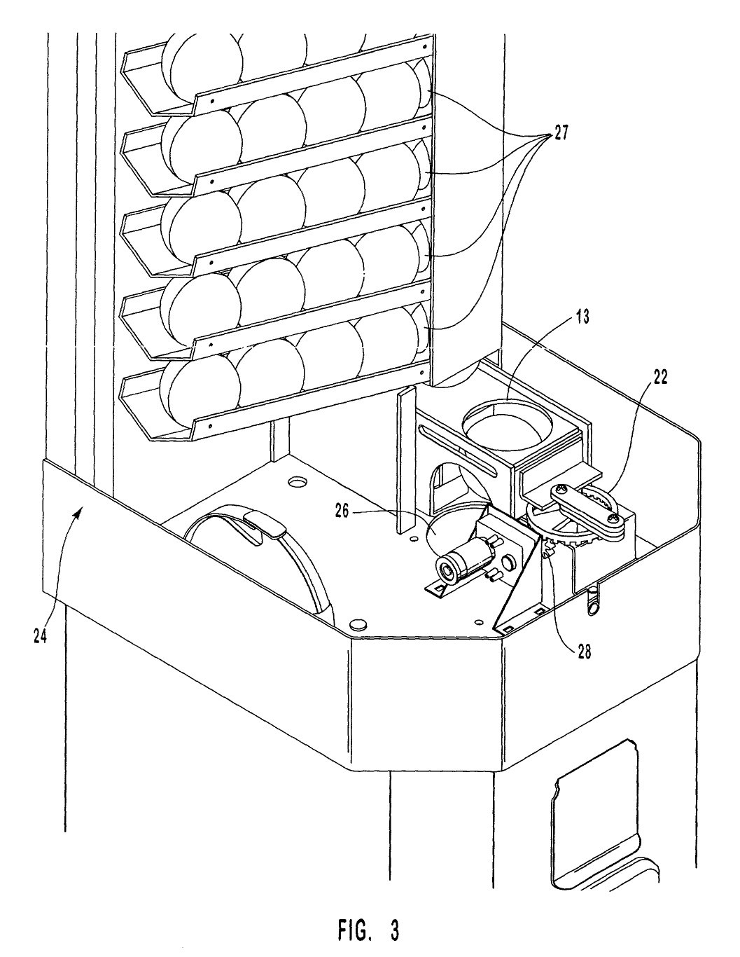

When a capsule 2 is to be delivered, an electronic switch causes the horizontal disc 22 to rotate in a substantially horizontal plane. In some embodiments (such as the embodiment shown in FIG. 3), the electronic switch activates a vertically oriented cog wheel 28 that connects with cogs on disc 22 to cause the latter disc 22 to rotate in the horizontal plane. Preferably, the electronic switch is physically oriented so as to avoid inadvertent destruction when a repair person works near the disc 22. Also, in the preferred embodiments, the electronic switch is activated only after a person inserts a token in an electronic token slot—and preferably after the person wins a game initiated by the insertion of the token into the slot. Tokens may include coins, arcade game tokens, bills, or the like.

As disc 22 rotates, bar 20 correspondingly rotates and pulls bar 18 so that the capsule transport 12 moves forward from the delivery chute 8. When bar 20 has rotated to the point where it overlaps with bar 18, the capsule transport 12 is at its forwardmost position (shown in FIG. 2) where the capsule in the transport 12 then is lined up with and falls down a hole 26 (shown in FIG. 3 where the capsule is shown just before it is about to fall down the hole 26) in a vending or game console 24 for delivery. It is important to note that any sort of mechanism (as opposed to a disc and bar mechanism) can be used to move the transport 12. Such a mechanism would include, for example, a simple motor.

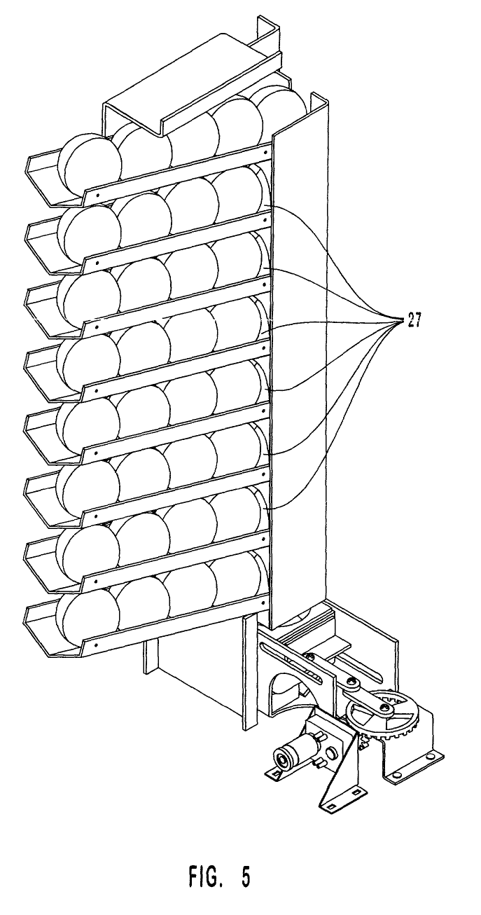

As can be seen by carefully comparing FIGS. 1 and 2, the delivery chute 8 is in a lowered resting position (which, for convenience, could also be referred to as a “first position”) in FIG. 1 and in a raised agitating position (which, for convenience, could be referred to as a “second position”) in FIG. 2. The side of the delivery chute 8 that is adjacent to the slanting channels 4 has holes 27 (best seen in FIG. 5) that are shaped to allow the capsules 2 in all but the topmost of the slanted channels 4 to abut the capsules 2 inside the delivery chute 8 when the delivery chute 8 is in its lowered resting position shown in FIG. 1. In other words, when the delivery chute 8 is in its first position, the capsules 2 in the slanting channels 4 are held back from entering the delivery chute 8 by the capsules 2 within the delivery chute 8.

When in its second position, the holes 27 of the delivery chute 8 block the capsules 2 in all of the slanting channels 4 except for the topmost of the channels 4 so that none of the next-in-line capsules 2 (i.e., the capsules 2 adjacent to the delivery channel 8) in the lower channels 4 can enter the delivery chute 8. After the column of capsules 2 is agitated by movement into this second position, the topmost next-in-line capsule falls into the top of the delivery chute 8.

A comparison of FIGS. 1 and 2 shows that the pivot bar 10 of the preferred embodiments moves the delivery chute 8 vertically upward away from the transport 12 as the transport 12 moves forward.

As the disc 22 continues its rotation, the capsule transport 12 is moved back to its original position, and the pivot bar 10 also returns to its original position, causing the delivery chute 8 to lower and allow the last capsule in the delivery chute 8 to fall into the hole 13 at the top of the capsule transport 12 in preparation for the next delivery.

The agitation of the delivery chute 8 against a set of slanted parallel channels 4 provides several advantages over the existing art. (Incidentally, it is immaterial whether the agitator column 8 is up while the transport 12 is resting or whether the column 8 is up while the transport 12 is in its forward position; likewise goes for when the agitator column 8 is down). For example, the parallel channel configuration provides a weight distribution of the rounded objects that minimizes breakage of capsules 2 that may be made of fragile material. Also, the parallel channel configuration makes it easy to de-jam the system should the capsule flow become jammed—with the present invention, a repair person need only reach into a single slanted channel 4 wherein the jam is located (as opposed to having to redistribute all the capsules in an entire hopper full of capsules). Moreover, the configuration of the present invention maximizes the use of space by lining up the capsules 2 in a parallel configuration instead of wasting space by heaping capsules in a random order.

FIG. 5 shows the embodiment of FIG. 1 shown from an inside angle.

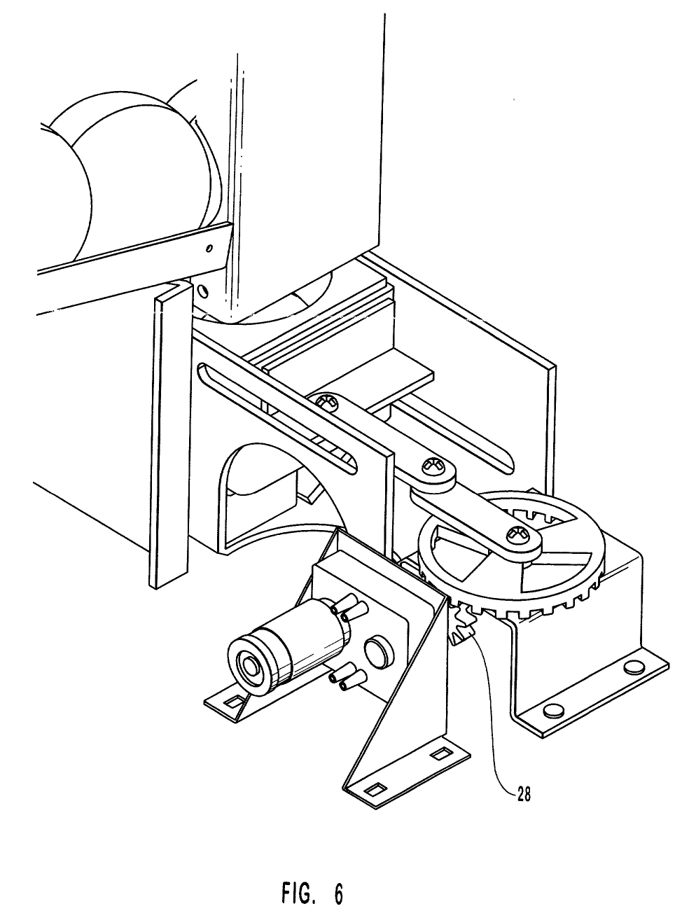

FIG. 6 shows an enlarged view of the bottom portion of FIG. 5.

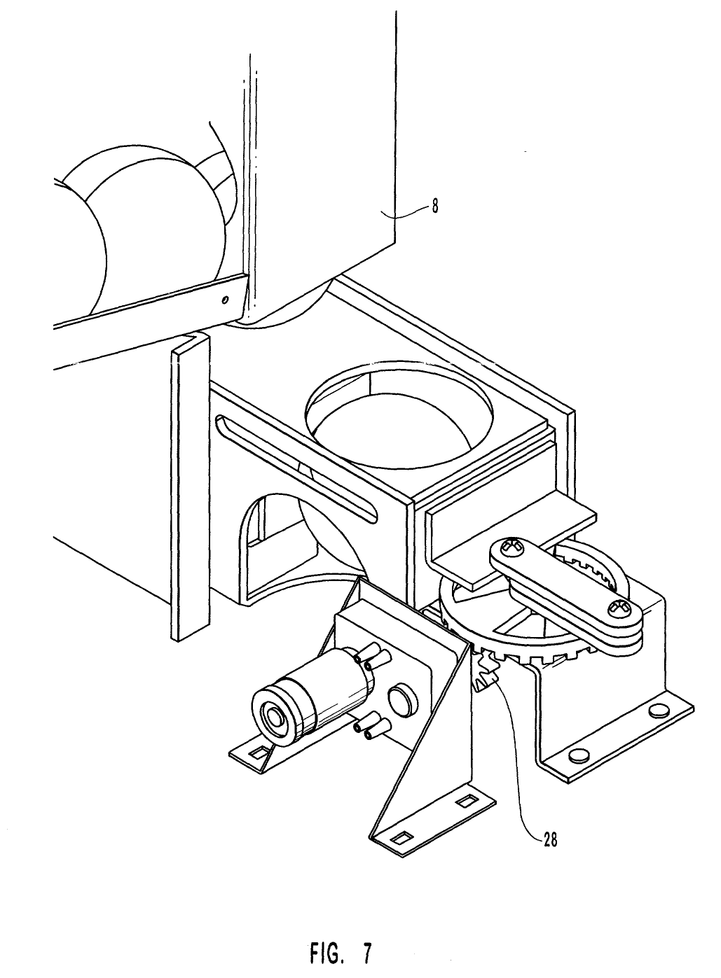

FIG. 7 shows an enlarged view of the bottom portion of FIG. 1.

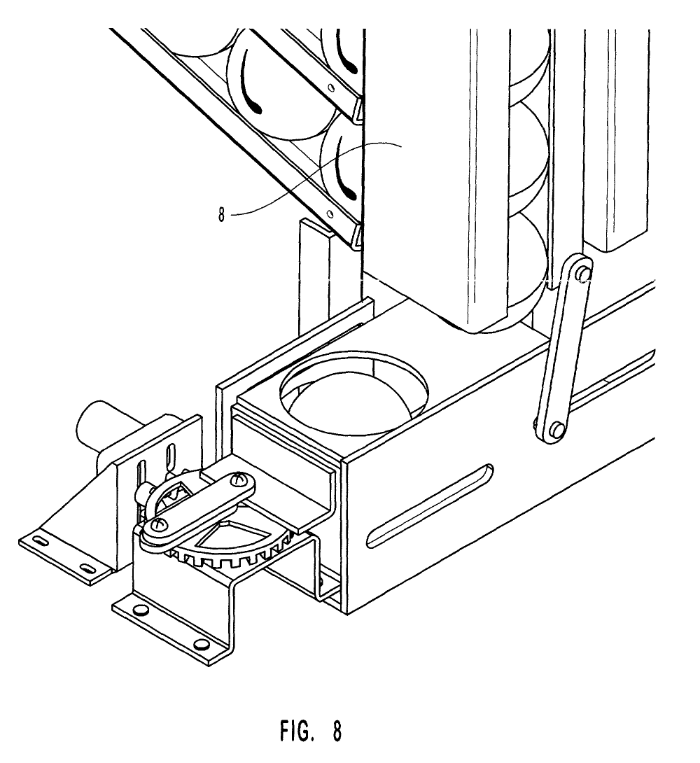

FIG. 8 shows an enlarged view of the bottom portion of FIG. 2.

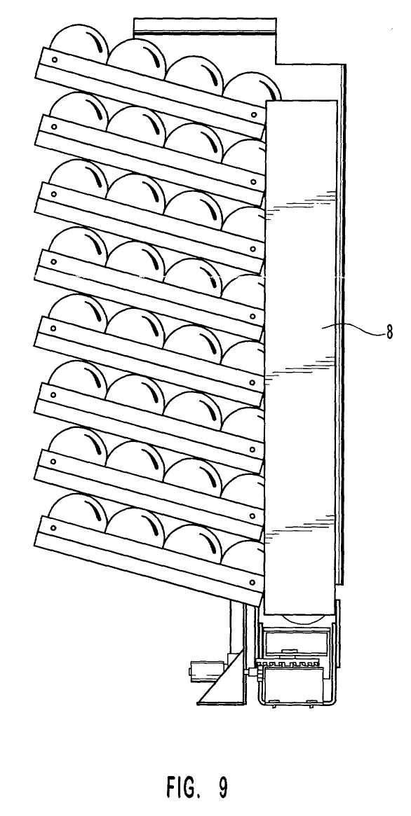

FIG. 9 shows a front plan view of the embodiment of FIG. 1.

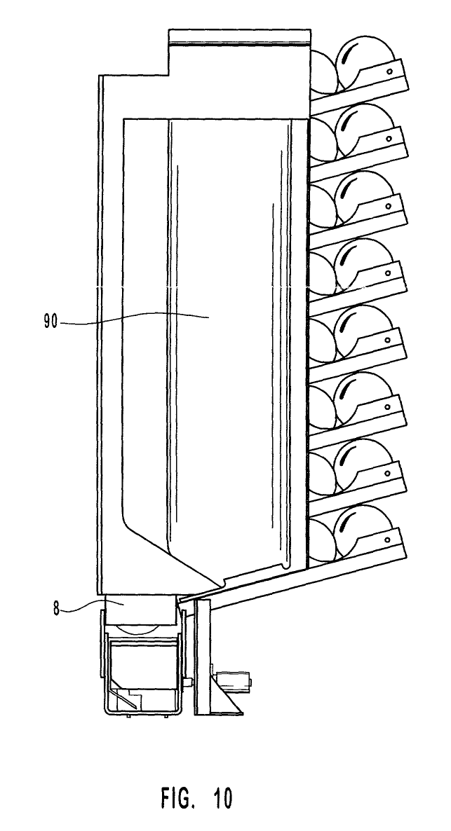

FIG. 10 shows a back plan view of the embodiment of FIG. 1. A small prize trough 90 can be seen here. The trough 90 serves as additional storage for small prizes (discussed below).

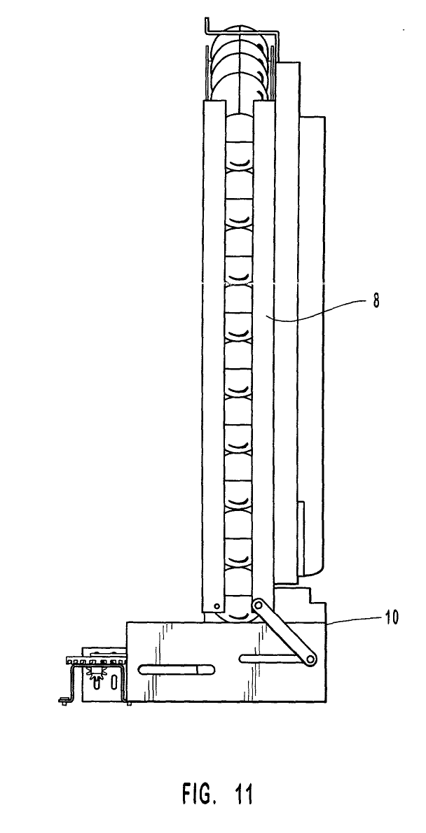

FIG. 11 shows a right side view of the embodiment of FIG. 1. Notice that the pivot bar 10 is at an angle when the delivery chute 8 is in its resting position.

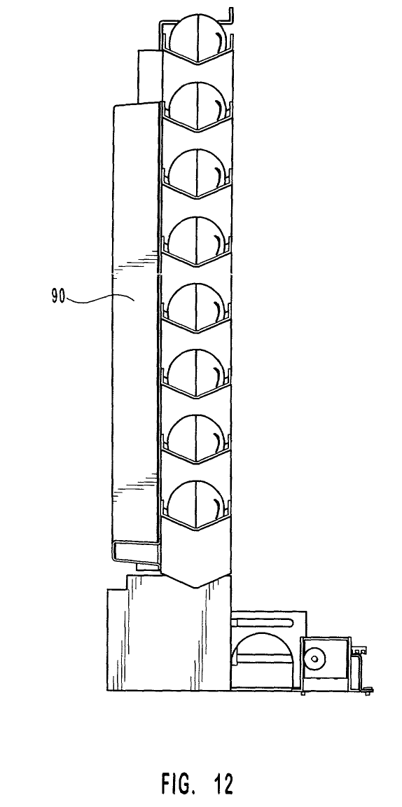

FIG. 12 shows a left side view of the embodiment of FIG. 1.

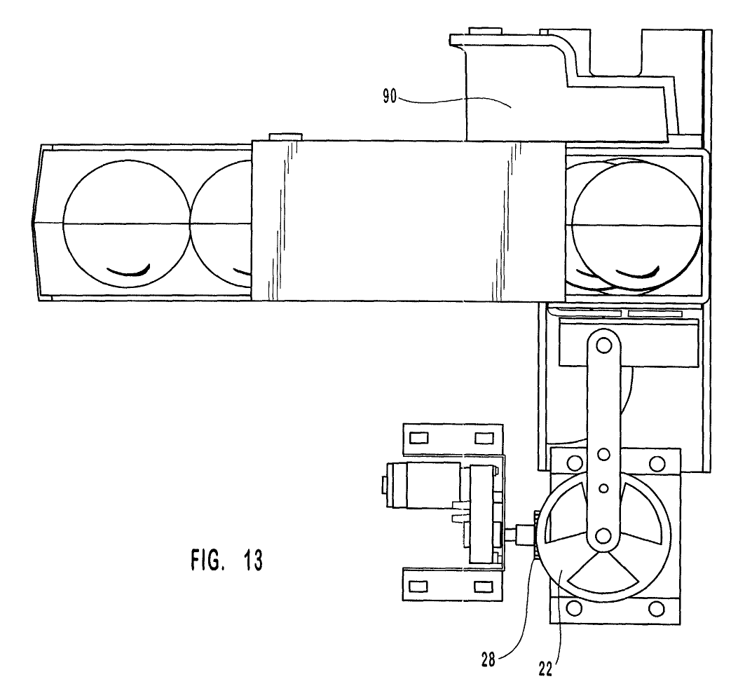

FIG. 13 shows a top plan view of the embodiment of FIG. 1.

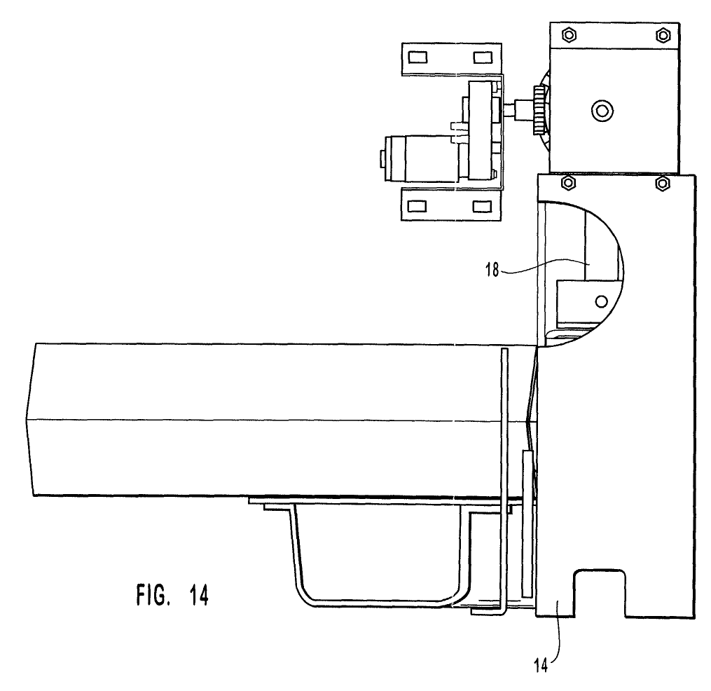

FIG. 14 shows bottom plan view of the embodiment of FIG. 1.

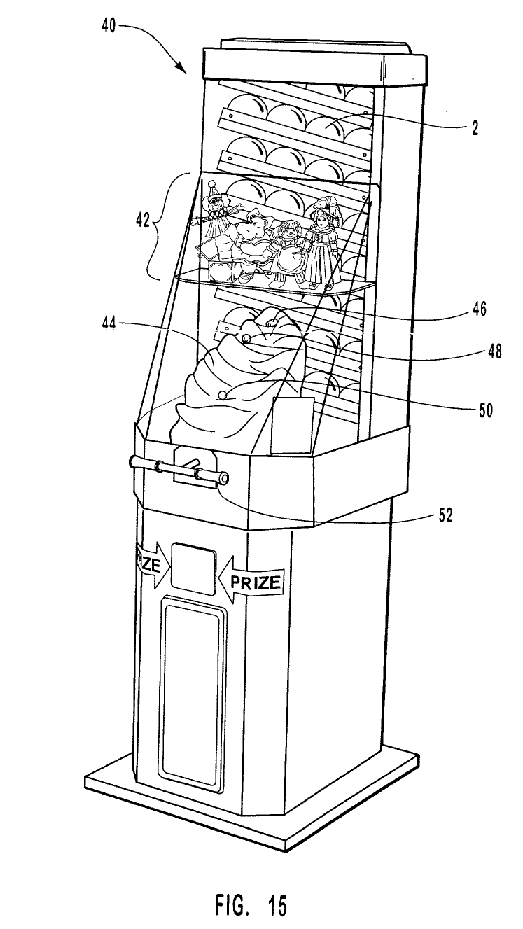

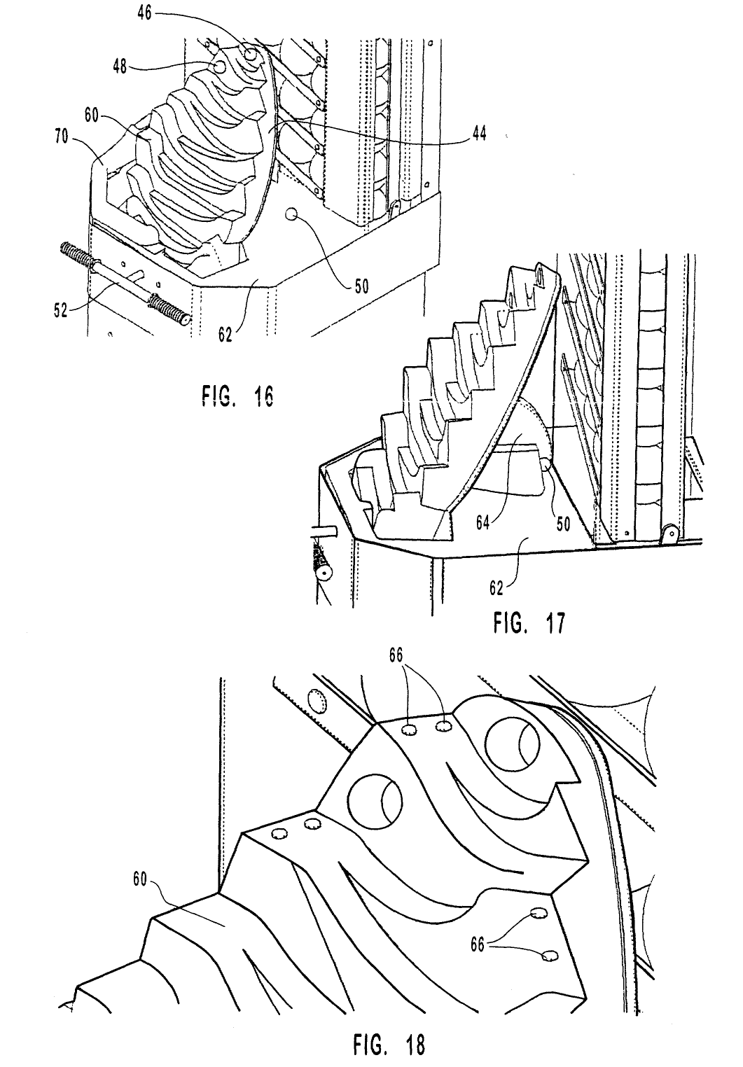

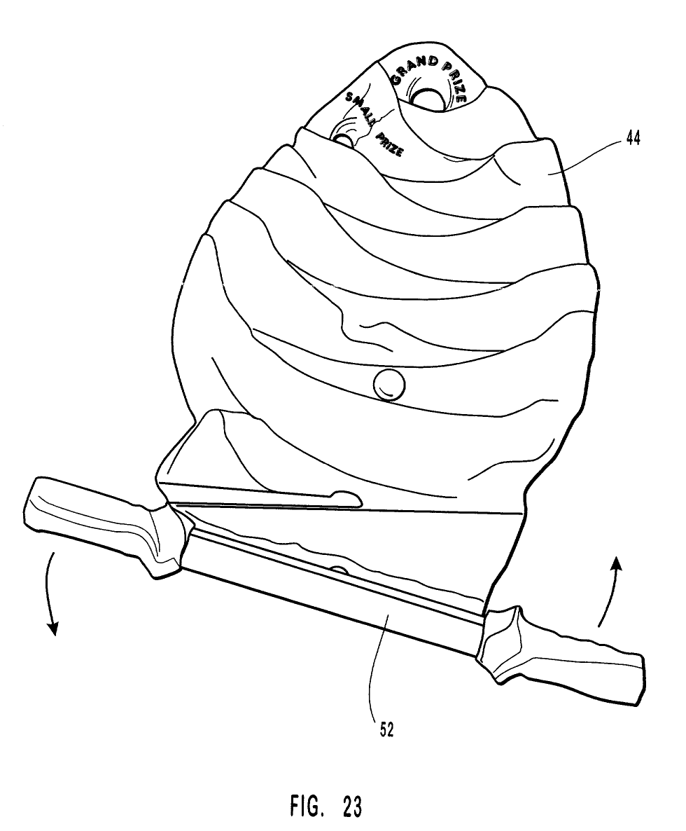

In the preferred embodiments, the delivery chute system described above is embodied in an interactive skill game that allows a player to instantly redeem his or her prize. As shown in FIG. 15, a game machine 40 has a ridged mountain or hill piece 44 that can be rocked from side to side by pivoting a handlebar 52 (which pivoting motion is illustrated best in FIG. 23). The ridged hill piece 44 has two holes near the top, hole 46 and hole 48 (seen more clearly in FIG. 16). When a player puts money into the machine 40, the player is provided with a ball 50 at the bottom of the hill piece 44.

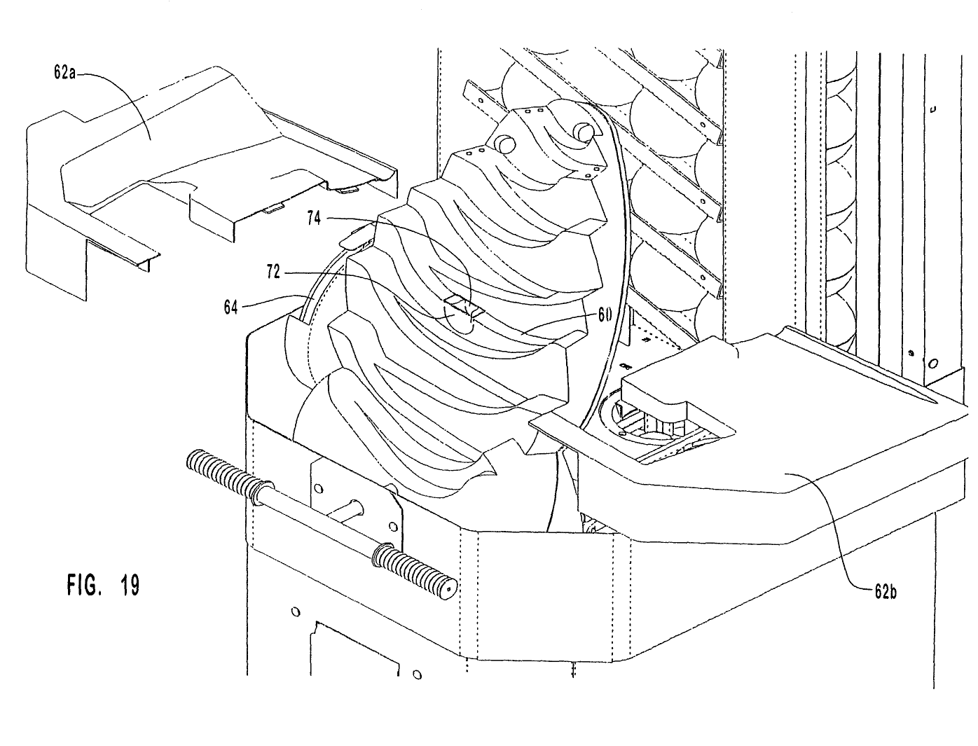

As shown in FIG. 17, the ball 50 is preferably delivered to the player by a ball delivery wheel 64 (shown also in FIG. 19) that drops the ball 50 through a tunnel 70 (shown in FIG. 16) for delivery to the bottom of the hill piece 44. The player then works the ball 50 up the hill 44 by rocking the hill 44 from side to side to move the ball successively up ridges 60 while trying not to let the ball 50 roll off the edge of the hill piece 44 and fall onto bottom tray 62. The machine 40 dispenses a small prize (not shown) if the player gets the ball 50 into the small prize hole 48; if the ball 50 falls into the large prize hole 46, the machine 40 dispenses a large prize encapsulated in a large capsule 2.

The small prize can be a gumball, a small encapsulated prize, or any other suitable prize item. Small prizes are stored in a cavity (not shown) inside the machine 40; extra storage space 90 (see FIG. 10) is also preferably provided should the cavity not be large enough to accommodate a desirable number of small prizes. The small prizes are preferably dispensed through a traditional gumball-type horizontal delivery wheel (not shown). Preferably, the large capsules 2 holding the large prizes are spherical and are around four inches in diameter.

In some embodiments of the present invention, there are removable parts, for example, bumpers 66 (shown in FIG. 18), to provide differing levels of difficulty. These bumpers are preferably made of rubber and are placed on the ridges 60 in strategic locations to assist in keeping the ball 50 in play by making it harder for the ball 50 to fall off the edge of the hill 44. One, two, three, or more bumpers 66 may be placed on one or more ridges 60. The bumpers 66 may be of any color and any appropriate shape. Also, the bumpers 66 need not be made of rubber but can be made of any appropriate material.

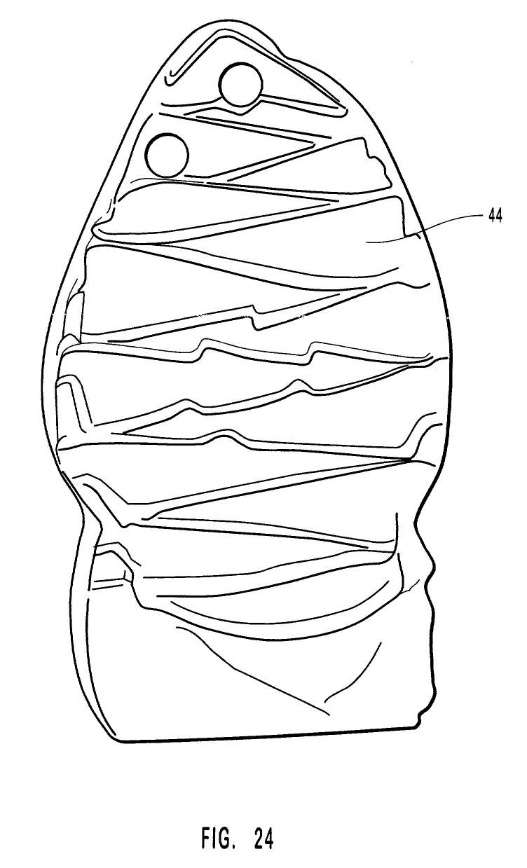

In the preferred embodiments of the present invention, the machine 40 incorporates a display 42 (see FIG. 15) to show samples of prizes. Some embodiments also have a hill piece 44 that can be replaced with other interchangeable hill pieces 44. Examples of some hill pieces 44 are shown in FIGS. 23 and 24.

FIG. 19 shows an exploded view of one embodiment of the present invention wherein the bottom tray 62 is comprised of a left bottom tray member 62a and a right bottom tray member 62b. Also, in this embodiment, the hill piece 44 has a dip 72 in one of the ridges 60 to increase the level of difficulty of the game. A player who moves the ball 50 too slowly over the dip 72 will cause the ball to fall in the dip 72 and possibly fall off the hill 44. Also, this embodiment may include a removable stick-on bridge 74 to bridge the gap of the dip 72 when an easier level of difficulty is desired. The bridge 74 is here shown to be transparent; however, the bridge can be opaque as well as have any appropriate shape as long as the bridge 74 bridges the dip 72 in the ridge 60.

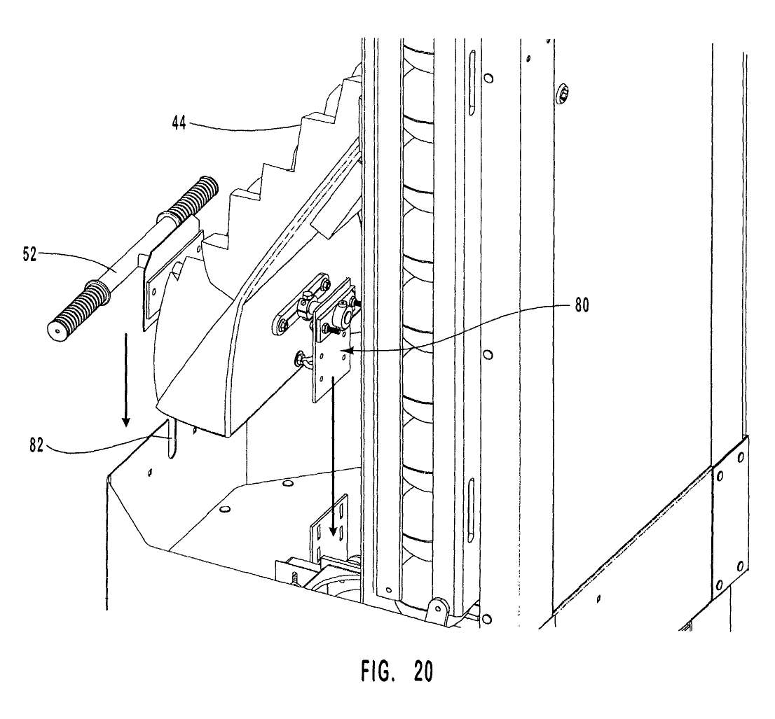

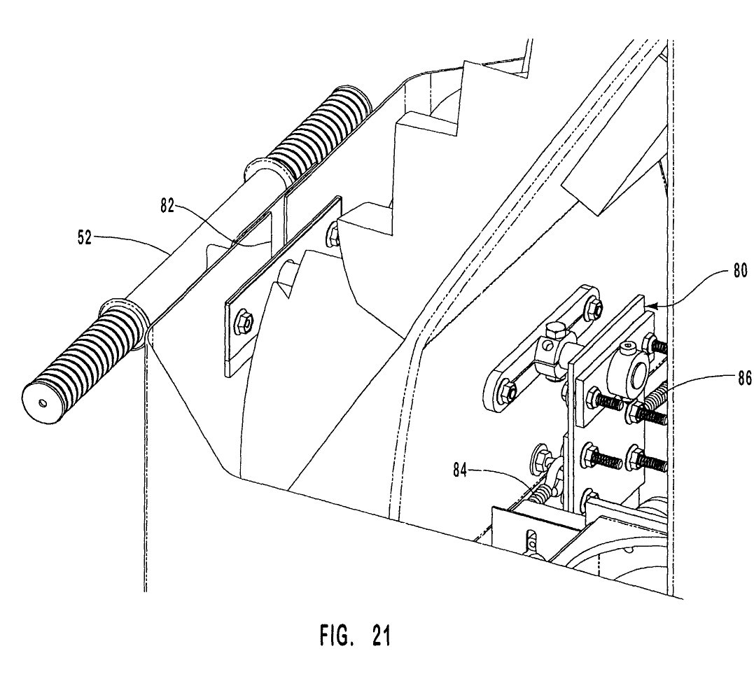

FIG. 20 shows an exploded view of one embodiment of the present invention wherein the hill piece 44 is separated from the machine 40. In this embodiment, a rocking mechanism 80 is shown fixed to the back of the hill piece 44 and to the handlebar 52. Also, an open u-shaped channel 82 is shown. This u-shaped channel 82 is where the neck of the handlebar 52 is placed; this open u-shaped configuration provides for easy access to the hill piece 44 and allows the hill piece 44 to be easily replaced.

FIG. 21 shows the handlebar 52 in FIG. 20 when placed in the u-shaped channel 82. FIG. 21 also shows guide springs 84 and 86 that guide the rocking of the hill piece 44.

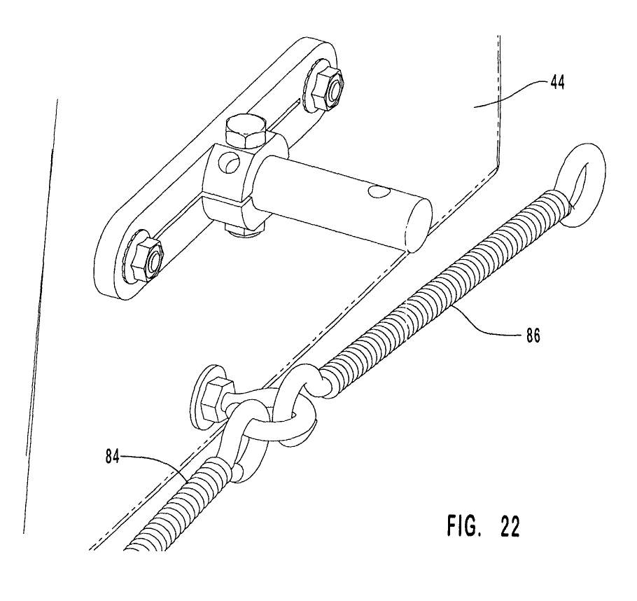

FIG. 22 is a partial view of the back of one embodiment of the hill piece 44. Here, guide springs 84 and 86 can be seen more clearly.

It should be noted that machine 40 can include various additional features, including sound effects, music, and an electronic display to indicate a time limit as well as for displaying a counter indicating the number of plays available.

It is underscored that the present invention may be embodied in other specific forms without departing from its spirit or essential characteristics. The described embodiments herein should be deemed only as illustrative. Indeed, the appended claims indicate the scope of the invention; the description, being used for illustrative purposes, does not limit the scope of the invention. All variations that come within the meaning and range of equivalency of the claims are to be embraced within their scope.

What is claimed is:

1. A method for delivering articles comprising:
storing rounded articles in at least one slanted channel that opens into a delivery chute so as to allow said rounded articles to pass into said delivery chute;
transporting one of said rounded articles from said delivery chute via an article transport to a desired location for delivery of said rounded article therethrough; and
returning said article transport to its original position whereby the next, lowermost rounded article in said delivery chute drops into said transport in preparation for the next delivery.

2. The method of claim 1 wherein said delivery chute moves in a substantially vertical direction when said transport moves.

3. The method of claim 1 wherein said delivery chute is attached to said transport via a pivot bar that moves said delivery chute when said transport is moved.

4. The method of claim 1 wherein said rotating disc is electronically activated only after insertion of a token into an electronic token slot.

5. The method of claim 1 further comprising a plurality of slanted channels and wherein said slanted channels all lie in one plane.

6. The method of claim 5 wherein said slanted channels all slant in one direction.

7. The method of claim 1 wherein said rounded articles comprise capsules of at least 4 inches in diameter.

8. The method of claim 1 wherein said delivery chute is movable within the same plane as the plane created by the slanted channels and wherein the transport is movable within a plane substantially perpendicular to said plane created by the slanted channels.

9. A method comprising:
storing rounded capsules in a plurality of fixed slanted channels that open into a substantially vertical delivery chute so that said rounded capsules can pass fall into said delivery chute;
electronically rotating a disc after a token is inserted into an electronic token slot, said disc being attached to a horizontally movable capsule transport, said transport being located beneath said delivery chute and adapted to transport at least one of said rounded capsules from said delivery chute;
mechanically moving said capsule transport via said step of rotating so that said capsule transport moves over a hole, thereby allowing a rounded capsule carried by said transport to drop into the hole for delivery;
simultaneous with said moving of said transport, mechanically moving said vertical delivery chute vertically upwards; and
continuing said step of electronically rotating until said disc moves said transport into a position whereby the lowermost rounded capsule in said delivery chute drops into said transport in preparation for the next delivery.

10. The method of claim 9 wherein said vertical delivery chute is attached to said transport via a pivot bar that pivots at its attachment to said delivery chute so that said delivery chute moves when said transport is moved.

11. The method of claim 9 wherein said fixed slanted channels all lie in one plane.

12. The method of claim 11 wherein said fixed slanted channels all slant in one direction.

13. The method of claim 9 wherein said capsules are at least 4 inches in diameter.

14. The method of claim 9 wherein said delivery chute is movable within the same plane as the plane created by the slanted channels and wherein the transport is movable within a plane substantially perpendicular to said plane created by the slanted channels.

15. A method comprising:
storing rounded capsules in a plurality of fixed slanted channels that open into a substantially vertical delivery chute so that said rounded capsules can pass into said delivery chute;
electronically rotating a disc after a player inserts a token into an electronic token slot and pivots a handlebar to pivot a ridged hill and thereby maneuver a ball up said hill and into a hole at the top of said hill, said disc being attached to a horizontally movable capsule transport, said transport being located beneath said delivery chute and adapted to transport at least one of said rounded capsules from said delivery chute;
mechanically moving said capsule transport via said step of rotating so that said capsule transport moves over a hole, thereby allowing a rounded capsule carried by said transport to drop into the hole for delivery;
simultaneous with said moving of said transport, mechanically moving said vertical delivery chute vertically upwards; and
continuing said step of electronically rotating until said disc moves said transport into a position whereby the lowermost rounded capsule in said delivery chute drops into said transport in preparation for the next delivery.

16. The method of claim 15 wherein said ridged hill is interchangeable with other ridged hills.

17. The method of claim 15 wherein the ridged hill further comprises removable pieces to vary the level of difficulty in moving said ball up said hill.

18. The method of claim 15 further comprising the step of delivering, when said ball is maneuvered into another hole in said ridged hill, a smaller prize.

19. A system comprising:
at least one slanted channel capable of receiving a plurality of rounded capsules;
a delivery chute, said slanted channel being open-ended so as to communicate with said delivery chute; and
a movable capsule transport located beneath said delivery chute and adapted to transport at least one of said rounded capsules from said delivery chute to a desired location.

20. The system of claim 19 wherein said delivery chute moves in a substantially vertical direction when said transport moves.

21. The system of claim 19 wherein said delivery chute is attached to said transport via a pivot bar that moves said delivery chute when said transport is moved.

22. The system of claim 19 wherein said rotating disc is electronically activated and only after insertion of a token into an electronic token slot.

23. The system of claim 19 further comprising a plurality of slanted channels and wherein said slanted channels all lie in one plane.

24. The system of claim 23 wherein said slanted channels all slant in one direction.

25. The system of claim 19 wherein said rounded capsules have a four inch diameter.

26. The system of claim 23 wherein said delivery chute is movable within the same plane as the plane created by the slanted channels and wherein the transport is movable within a plane substantially perpendicular to said plane created by the slanted channels.

27. A system comprising:
a plurality of rounded capsules;
a plurality of fixed slanted channels for storing said rounded capsules;
an open-sided, substantially vertical delivery chute, said slanted channels being open-ended so that said rounded capsules can pass into said delivery chute;
a horizontally movable capsule transport wherein said transport is located beneath said delivery chute and is adapted to transport at least one of said rounded capsules from said delivery chute, said delivery chute moving upwards when said capsule transport moves;
a horizontally rotatable disc attached to said capsule transport for moving said capsule transport when said disc rotates, said disc being electronically rotated only after a token is inserted into an electronic token slot; and
a hole located underneath said capsule transport when said disc has rotated 180 degrees from its original orientation, said hole being the means through which a capsule carried by said transport travels for delivery.

28. The system of claim 27 wherein said vertical delivery chute is attached to said transport via a pivot bar that pivots at its attachment to said delivery chute so that said delivery chute moves when said transport is moved.

29. The system of claim 27 wherein said fixed slanted channels all lie in one plane.

30. The system of claim 29 wherein said fixed slanted channels all slant in one direction.

31. The system of claim 27 wherein said capsules are at least 4 inches in diameter.

32. The system of claim 27 wherein said delivery chute is movable within the same plane as the plane created by the slanted channels and wherein the transport is movable within a plane substantially perpendicular to said plane created by the slanted channels.

33. A system comprising:
a plurality of rounded capsules;
a plurality of fixed slanted channels for storing said rounded capsules;
an open-sided, substantially vertical delivery chute, said slanted channels being open-ended so that said rounded capsules can pass into said delivery chute;
a horizontally movable capsule transport wherein said transport is located beneath said delivery chute and is adapted to receive and transport at least one of said rounded capsules from said delivery chute, said transport receiving the lowermost of said capsules via the natural force of gravity;
a horizontally rotatable disc attached to said capsule transport for moving said capsule transport when said disc rotates, said disc being electronically rotated only after a player inserts a token into an electronic token slot and pivots a handlebar to pivot a ridged hill and thereby maneuver a ball up said hill and into a hole at the top of said hill;
a hole located underneath said capsule transport when said disc has rotated 180 degrees from its original orientation, said hole being the means through which a capsule carried by said transport travels for final delivery;
an interchangeable hill piece electronically connected to said disc, said hill piece having a top portion and a bottom portion, said hill piece having a pivot point at said bottom portion, said hill piece comprising a plurality of ridges;
a handlebar fixedly attached to the bottom portion of said hill piece for pivoting said ridged hill piece; and
a plurality of removable stick-on bumpers attached to at least one of said ridges on said hill piece.
